(19) United States
(12) Patent Application Publication
(10) Pub. No.: US 2008/0081155 A1
(43) Pub. Date: Apr. 3, 2008

(54) Plated substrate and method of manufacturing the same

(75) Inventors: Toshihiko Kaneda, Hakusan (JP); Satoshi Kimura, Fujimi (JP); Hidemichi Furihata, Chino (JP); Jun Amako, Matsumoto (JP); Daisuke Sawaki, Shiojiri (JP); Takeshi Kijima, Matsumoto (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/906,553

(22) Filed: Oct. 2, 2007

(30) Foreign Application Priority Data
Oct. 3, 2006 (JP) 2006-271805

(51) Int. Cl. B32B 3/00; B05D 1/18; B05D 3/02; B32B 15/04

(52) U.S. Cl. 428/172; 427/385.5; 427/431; 428/457

(57) ABSTRACT

A method of manufacturing a plated substrate using electroless plating to form a metal layer, the method including: forming a resin section having a predetermined pattern on a substrate; forming a catalyst layer on the resin section; and depositing a metal on the catalyst layer by immersing the substrate in an electroless plating solution to form a metal layer.

Japanese Patent Application No. 2006-271805, filed on Oct. 3, 2006, is hereby incorporated by reference in its entirety.

### BACKGROUND OF THE INVENTION

The present invention relates to a plated substrate and a method of manufacturing the same.

Metal wires and the like are formed on a substrate using a subtractive method, for example. In the subtractive method, a metal layer is formed over the whole surface of a substrate, and a photoresist is applied to the metal layer and patterned. The metal layer is then etched using the photoresist as a mask. Such a method has a problem in which resources and materials are wasted due to removal of the photoresist and partial removal of the metal layer.

### SUMMARY

According to a first aspect of the invention, there is provided a plated substrate having a metal layer formed by electroless plating, the plated substrate comprising:

a resin section formed on a substrate and having a predetermined pattern;

a catalyst layer formed on the resin section; and

a metal layer formed on the catalyst layer.

According to a second aspect of the invention, there is provided a method of manufacturing a plated substrate using electroless plating to form a metal layer, the method comprising:

(a) forming a resin section having a predetermined pattern on a substrate;

(b) forming a catalyst layer on the resin section; and

(c) depositing a metal on the catalyst layer by immersing the substrate in an electroless plating solution to form a metal layer.

### BRIEF DESCRIPTION OF THE SEVERAL VIEWS OF THE DRAWING

FIG. 1 is a diagram showing a method of manufacturing a plated substrate according to one embodiment of the invention.

FIG. 2 is a diagram showing a method of manufacturing a plated substrate according to one embodiment of the invention.

FIG. 3 is a diagram showing a method of manufacturing a plated substrate according to one embodiment of the invention.

FIG. 4 is a diagram showing a method of manufacturing a plated substrate according to one embodiment of the invention.

FIG. 5 is a diagram showing a method of manufacturing a plated substrate according to one embodiment of the invention.

FIG. 6 is a diagram showing a method of manufacturing a plated substrate according to one embodiment of the invention.

FIG. 7 is a diagram showing a method of manufacturing a plated substrate according to one embodiment of the invention.

FIG. 8 is a diagram showing a method of manufacturing a plated substrate according to one embodiment of the invention.

FIG. 9 is a diagram showing a method of manufacturing a plated substrate according to one embodiment of the invention.

FIG. 10 is a diagram showing a method of manufacturing a plated substrate according to one embodiment of the invention.

FIG. 11 is a diagram showing a method of manufacturing a plated substrate according to one embodiment of the invention.

FIG. 12 is a cross-sectional diagram showing a plated substrate according to one embodiment of the invention.

FIG. 13 is a perspective view showing a plated substrate according to one embodiment of the invention.

FIG. 14 is a diagram showing an example of an electronic device to which a plated substrate according to one embodiment of the invention is applied.

FIG. 15 shows an SEM image of a plated substrate according to an experimental example of the invention.

### DETAILED DESCRIPTION OF THE EMBODIMENT

The invention may provide a plated substrate in which a fine pattern is formed with high accuracy, and a method of manufacturing the same.

According to one embodiment of the invention, there is provided a plated substrate having a metal layer formed by electroless plating, the plated substrate comprising:

a resin section formed on a substrate and having a predetermined pattern;

a catalyst layer formed on the resin section; and

a metal layer formed on the catalyst layer.

In this invention, when a component B is formed on a specific component A, the component B may be directly formed on the component A, or another component may be interposed between the component B and the component A.

In this plated substrate, the metal layer may be formed above part of the substrate on which the resin section is formed and also above remaining part of the substrate on which the resin section is not formed; and a thickness of the metal layer at a position above the part of the substrate on which the resin section is formed may be greater than a thickness of the metal layer at a position above the remaining part of the substrate on which the resin section is not formed.

This plated substrate may further comprise a catalyst adsorption layer formed between the resin section and the catalyst layer.

In this plated substrate, the resin section may include a photoresist.

In this plated substrate, the substrate may be a transparent substrate transmitting light having a predetermined wavelength.

According to one embodiment of the invention, there is provided a method of manufacturing a plated substrate using electroless plating to form a metal layer, the method comprising:

(a) forming a resin section having a predetermined pattern on a substrate;

(b) forming a catalyst layer on the resin section; and

(c) depositing a metal on the catalyst layer by immersing the substrate in an electroless plating solution to form a metal layer.

Since the method of manufacturing a plated substrate according to the above embodiment can form the metal layer without removing the resin section, resource consumption can be suppressed. Moreover, since a metal layer having a shape corresponding to the shape of the resin section can be formed, a metal layer having a fine pattern can be formed with higher accuracy.

In this method of manufacturing a plated substrate, the step (a) may include:

applying a resin material in a fluid state to the substrate;

pressing a nanostamper having a predetermined recessed pattern against the substrate to transfer the predetermined recessed pattern to the resin material; and

curing the resin material.

In this method of manufacturing a plated substrate, an upper portion of the cured resin material and a portion of the cured resin material not having the transferred predetermined pattern may be removed by ashing between the steps (a) and (b).

In this method of manufacturing a plated substrate, the resin section may include a photoresist; and the resin section may be formed by an interference exposure method in the step (a).

This method of manufacturing a plated substrate may further comprise:

(d) removing part of the resin section by immersing the substrate in an alkaline solution between the steps (a) and (b).

This method of manufacturing a plated substrate may further comprise:

forming a catalyst adsorption layer on the resin section on the substrate between the steps (d) and (b).

Between the steps (a) and (b) in this method of manufacturing a plated substrate, part of the resin section may be removed and a surfactant layer may be formed on the resin section on the substrate by immersing the substrate in an alkaline surfactant solution.

Some embodiments of the invention will be described below with reference to the drawings.

### 1. METHOD OF MANUFACTURING PLATED SUBSTRATE

FIGS. 1 to 10 are diagrams showing a method of manufacturing a plated substrate 100 (see FIG. 12) according to a first embodiment. In this embodiment, a plated substrate is manufactured by electroless plating.

(1) A substrate 10 is provided. The substrate 10 may be an insulating substrate, as shown in FIG. 1. A wiring board may be manufactured by forming a metal layer on the insulating substrate by steps described later. The substrate 10 may be an optically-transparent substrate (e.g. transparent substrate) which transmits visible light. An optical element such as a polarizer or a retardation film may be manufactured by forming a metal layer on the optically-transparent substrate by steps described later

The substrate 10 may be an organic substrate (e.g. plastic material or resin substrate) or an inorganic substrate (e.g. quartz glass, silicon wafer, or oxide layer). Examples of the plastic material include polyimide, polyethylene terephthalate, polycarbonate, polyphenylene sulfide, polyethylene terephthalate, and the like. The substrate 10 includes a single-layer substrate and a multilayer substrate in which at least one insulating layer is formed on a base substrate. In this embodiment, a metal layer is formed on the substrate 10. The substrate 10 preferably has a flat surface. It is desirable that the height of unevenness on the surface of the substrate 10 be less than 10 nanometers, for example.

A resin section 22c with a predetermined pattern is formed on the substrate 10. As the method of forming the resin section 22c, a known method such as an interference exposure method or a nanoimprint technology may be used. This embodiment illustrates the case of forming the resin section 22c using the nanoimprint technology.

As shown in FIG. 1, a resin material 22a in a fluid state is applied to the substrate 10. A thermosetting resin, a thermoplastic resin, a photocurable resin, or the like may be used as the resin material 22a. As the application method, a known method such as a spin coating method may be used.

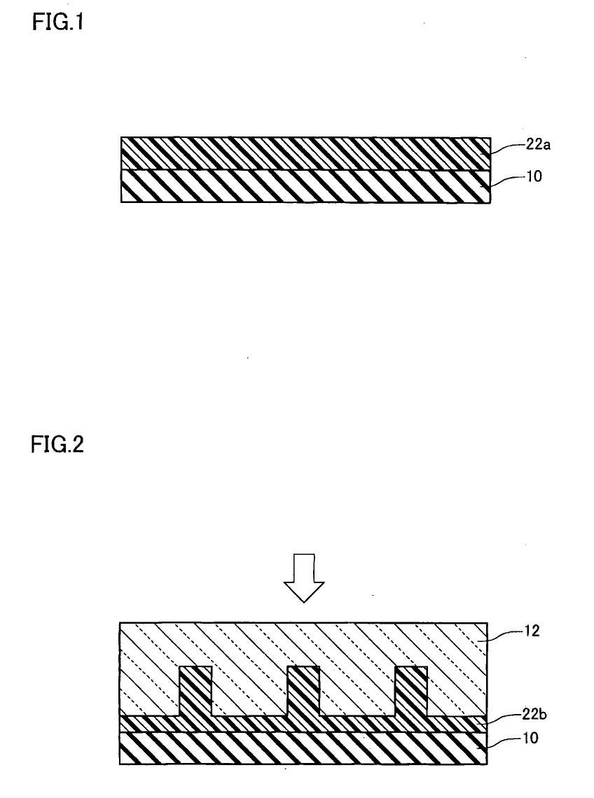

A nanostamper 12 is then pressed in the direction of the substrate 10 (the arrow direction in FIG. 2) to transfer a predetermined pattern to the resin material. The predetermined pattern may be a periodic pattern having lines arranged at uniform intervals. When the resin material 22a is a photocurable resin, an optically transparent nanostamper 12 may be used.

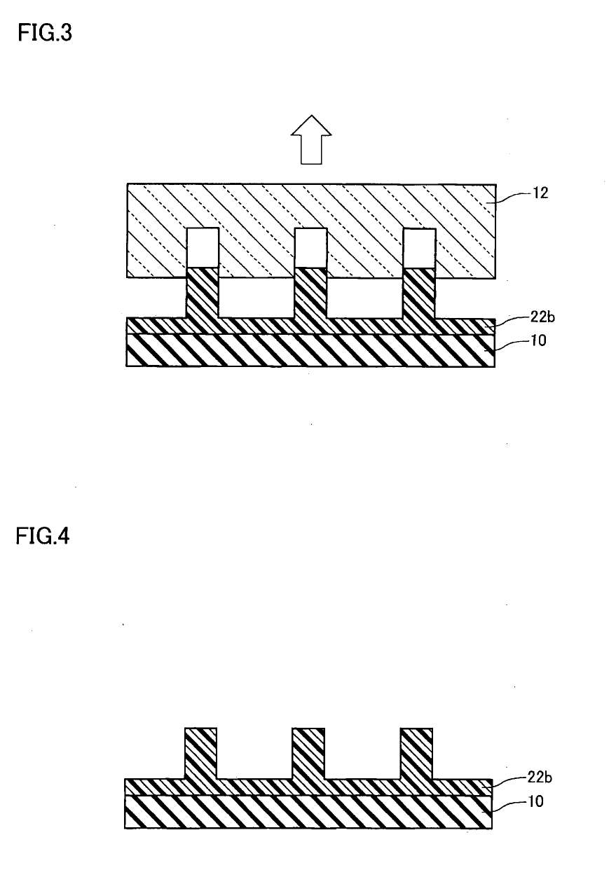

After curing a resin section 22b, the nanostamper 12 is removed from the resin section 22b (see FIG. 3). The resin section 22b having the predetermined pattern is thus formed, as shown in FIG. 4.

A step (2) described later may be performed using the resin section 22b. Alternatively, the resin section 22b in the region other than the predetermined pattern may be partially removed by etching back or the like. When the resin section 22b includes a photoresist, the resin section 22b may be partially removed by ashing. In this case, the upper portion of the resin section 22b in the region of the predetermined pattern is also removed together with part of the resin section 22b provided in the region other than the predetermined pattern. The resin section 22c is formed by the above removing step.

The method of forming the resin section 22c using the nanoimprint technology is described above. Note that the resin section 22c may also be formed by the interference exposure method, as described above. When using the interference exposure method, it is preferable to apply a photoresist as the resin material 22a and provide an antireflective film on the substrate 10 in advance.

(2) The substrate 10 and the resin section 22c are washed. The substrate 10 may be dry-washed or wet-washed. It is preferable to dry-wash the substrate 10. Dry washing prevents the resin section 22c from being damaged (e.g. separated).

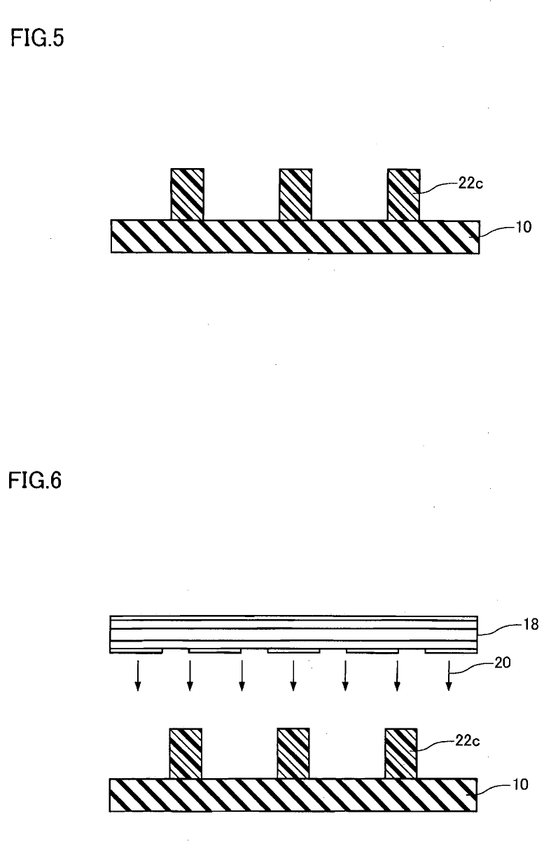

As shown in FIG. 6, dry washing may be performed by irradiating the substrate 10 and the resin section 22c with vacuum ultraviolet rays 20 for 30 to 900 seconds in a nitrogen atmosphere using a vacuum ultraviolet lamp 18 (wavelength: 172 nanometers, output: 10 milliwatts, distance from the sample: 1 millimeters). Soil such as oils and fats adhering to the surface of the substrate 10 can be removed by washing the substrate 10. Moreover, the water-repellent surfaces of the substrate 10 and the resin section 22c can be made hydrophilic. When the surface potential in liquid of the substrate 10 is negative, a surface at a uniform negative potential can be formed by washing the first support substrate 10.

The substrate 10 and the resin section 22c may be wet-washed by immersing the substrate 10 and the resin section 22c in ozone water (ozone concentration: 10 ppm to 20 ppm) at room temperature for 5 minutes to 30 minutes, for example.

(3) A catalyst adsorption layer 24 containing a surfactant or a silane coupling agent is formed on the substrate 10.

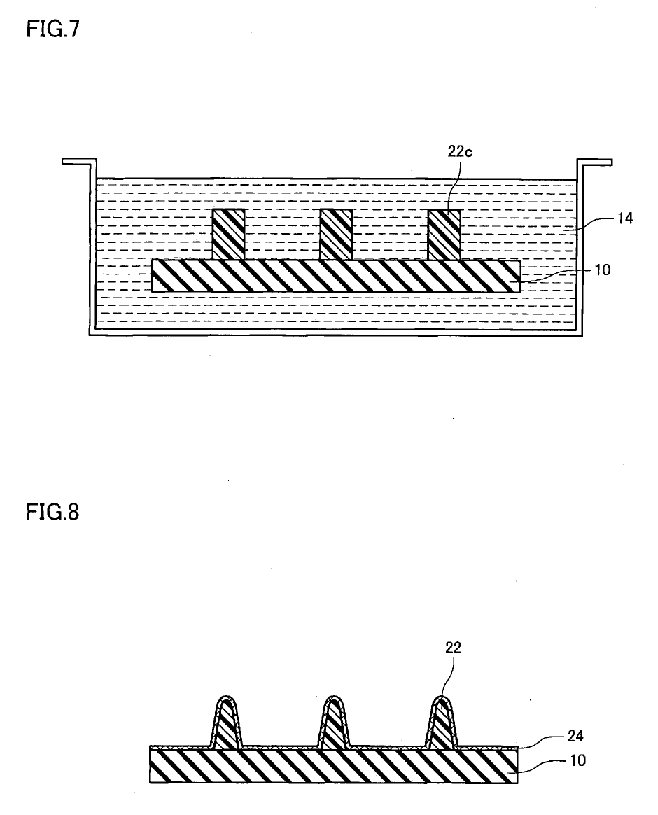

As shown in FIG. 7, the substrate 10 is immersed in a catalyst adsorption solution 14 in which a surfactant or a silane coupling agent is dissolved. When the surface potential in liquid of the substrate 10 is negative, it is preferable to use a cationic surfactant. This is because the cationic surfactant is easily adsorbed on the substrate 10 in comparison with other surfactants.

As the cationic surfactant, a water-soluble surfactant containing an aminosilane component, an alkylammonium surfactant (e.g. cetyltrimethylammonium chloride, cetyltrimethylammonium bromide, or cetyldimethylammonium bromide), or the like may be used. As the silane coupling agent contained in the catalyst adsorption solution 14, hexamethyldisilazane or the like may be used. The immersion time may be about 1 minute to 15 minutes, for example.

The substrate 10 is then removed from the catalyst adsorption solution 14 and washed with ultrapure water. After air-drying the substrate 10 at room temperature or removing waterdrops from the substrate 10 by spraying compressed air, the substrate 10 is dried in an oven at 90° C. to 120° C. for about 10 minutes to 1 hour. The catalyst adsorption layer 24 can be formed on the substrate 10 by the above steps, as shown in FIG. 8. When using the cationic surfactant as the surfactant, the surface potential in liquid of the substrate 10 is shifted to the positive potential side in comparison with the surface potential before adsorption.

The resin section 22c is partially removed by immersing the substrate 10 in the catalyst adsorption solution 14 to form a shape shown in FIG. 8. Specifically, the resin section 22c is partially removed so that the outer portion of the resin section 22c in contact with the catalyst adsorption solution 14 is removed (shaved). The resin section 22c is partially removed by dissolution when the catalyst adsorption solution 14 is alkaline (e.g. 11 pH to 12 pH). The dimensions of the resin section 22c can be thus changed. The dimensions of the resin section 22c can be controlled by adjusting the immersion time of the substrate 10 in the catalyst adsorption solution 14 and the pH of the catalyst adsorption solution 14.

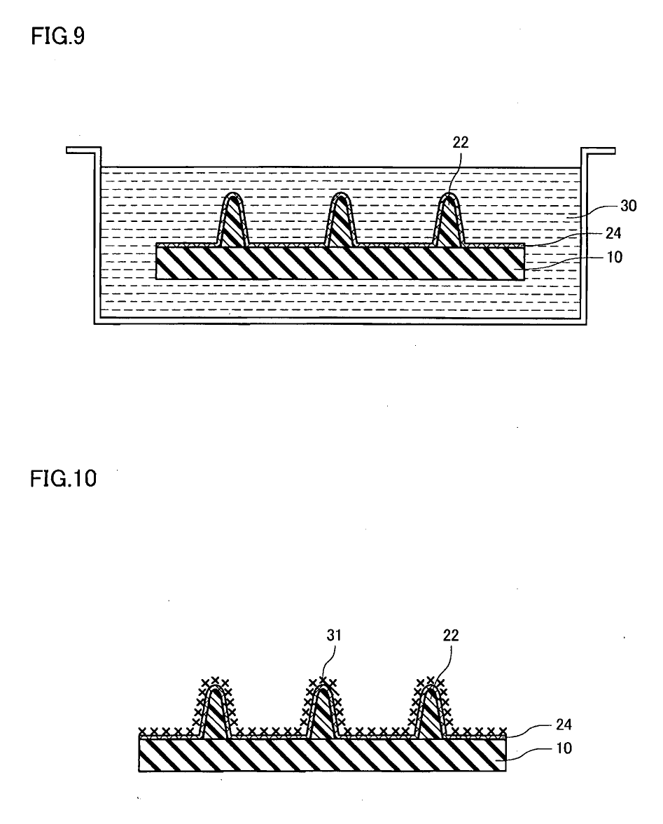

(4) A catalyst layer 31 is formed on the substrate 10. As shown in FIG. 9, the substrate 10 is immersed in a catalyst solution 30. The catalyst solution 30 includes a catalyst component which functions as a catalyst for electroless plating. For example, palladium may be used as the catalyst component.

The catalyst solution 30 may be prepared as follows, for example.

(4a) Palladium pellets with a purity of 99.99% are dissolved in a mixed solution of hydrochloric acid, a hydrogen peroxide solution, and water to prepare a palladium chloride solution with a palladium concentration of 0.1 to 0.5 g/l.

(4b) The palladium concentration of the palladium chloride solution is adjusted to 0.01 to 0.05 g/l by diluting the palladium chloride solution with water and a hydrogen peroxide solution.

(4c) The pH of the palladium chloride solution is adjusted to 4.5 to 6.8 using a sodium hydroxide aqueous solution or the like.

The substrate 10 may be washed with water after immersion in the catalyst solution 30. The substrate 10 may be washed with pure water. A catalyst residue can be prevented from being mixed into an electroless plating solution described later by washing the substrate 10 with water.

The catalyst layer 31 is formed by the above steps. As shown in FIG. 10, the catalyst layer 31 is formed on the top surface of the catalyst adsorption layer 24 on the substrate 10 and the resin section 22.

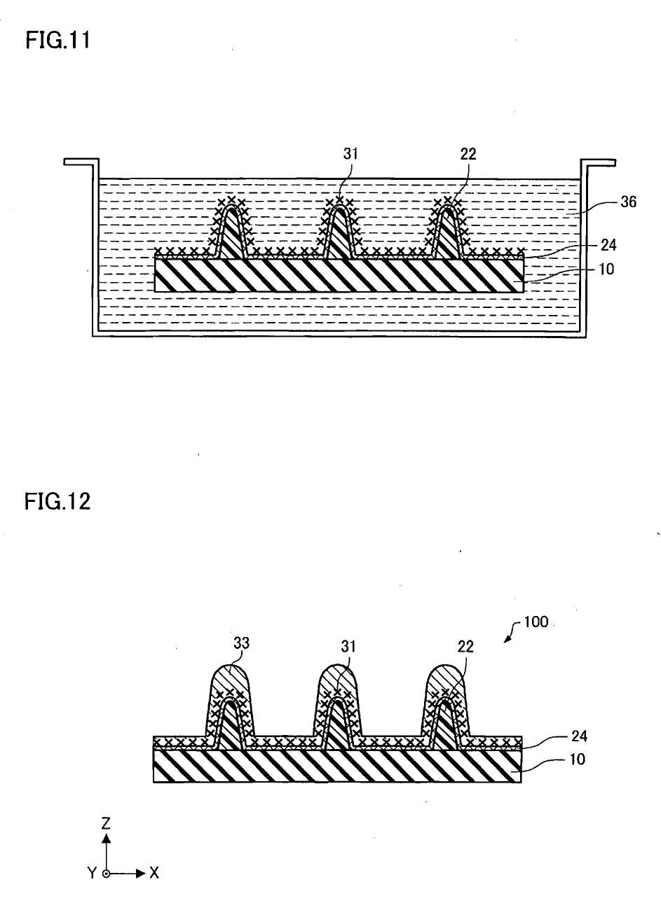

(5) A metal layer 33 is formed on the substrate. Specifically, the metal layer 33 is formed in the region in which the catalyst layer 31 is formed. As shown in FIG. 11, the metal layer 33 may be deposited by immersing the substrate 10 in an electroless plating solution 36 containing a metal. The electroless plating solution 36 is preferably prepared so that plating particles deposited on the substrate 10 have an average particle size of 20 nanometers to 50 nanometers. Such an electroless plating solution 36 may be prepared by changing the pH, temperature, preparation time, and the like. When the substrate 10 is immersed in the electroless plating solution 36 for a period of time equal to or longer than a predetermined period of time, the average particle size of the plating particles becomes greater than 50 nanometers. Therefore, it is preferable that the immersion time be equal to or less than the predetermined period of time.

The metal may be nickel, for example. The electroless plating solution 36 is classified into an electroless plating solution used in an acidic region and an electroless plating solution used in an alkaline region. As an example of the electroless plating solution 36, a solution used in an acidic region is applied. The electroless plating solution 36 contains the above metal, a reducing agent, a complexing agent, and the like. Specifically, the electroless plating solution 36 may be used which mainly contains nickel sulfate hexahydrate or nickel chloride hexahydrate and contains sodium hypophosphite as the reducing agent. For example, a nickel layer with a thickness of 20 nanometers to 100 nanometers may be formed by immersing the substrate 10 in an electroless plating solution (temperature: 70 to 80° C.) containing nickel sulfate hexahydrate for about 10 seconds to 10 minutes.

The metal layer 33 can be thus formed on the top surface of the catalyst layer 31 on the substrate 10, as shown in FIG. 12.

The substrate 10 may be washed with water after immersion in the electroless plating solution. The substrate 10 may be washed with pure water, steam, or pure water and steam. The substrate 10 may be dried by heating after washing with water. This improves the adhesion of the metal layer 33 to the substrate 10.

A plated substrate 100 can be formed by the above steps, as shown in FIG. 12. The metal layer 33 of the plated substrate 100 is formed on the top surface and the side surface of the resin section 22. The resin section 22 can function as a core for the metal layer 33. The metal layer 33 may also be formed in the region other than the resin section 22 (i.e., region other than the predetermined pattern). The method of manufacturing the plated substrate 100 according to this embodiment can make the metal layer 33 on the resin section 22 thicker than the metal layer 33 provided in the region other than the predetermined pattern. The reasons therefor are estimated as follows.

In the method of manufacturing the plated substrate 100 according to this embodiment, the metal layer 33 is deposited by immersing the substrate 10 in the electroless plating solution 36. The metal layer 33 is formed by an electroless plating reaction. The electroless plating reaction is a reduction reaction between the reducing agent and metal ions in the electroless plating solution, in which the metal ions receive electrons from the reducing agent, whereby plating particles are deposited. Since this reaction is promoted by the catalyst included in the catalyst layer 31, the reaction mainly proceeds near the catalyst layer 31. Since metal ions exist as aggregates in the electroless plating solution, plating particles (i.e., aggregates of metal atoms) are deposited by the reduction reaction. The size of the metal ion aggregates can be controlled by adjusting the pH and the temperature of the electroless plating solution, the immersion time, and the like.

In this embodiment, the plating particles in the electroless plating solution 36 are introduced into the region other than the resin section 22, whereby the metal layer 33 can also be deposited in the region other than the resin section 22 (i.e., region other than the predetermined pattern). The electroless plating solution 36 located on the resin section 22 has a high fluidity as compared with the electroless plating solution 36 located in the region other than the resin section 22. Therefore, the electroless plating solution 36 located near the top surface of the resin section 22 can maintain an almost constant metal ion concentration due to high fluidity, even if the metal ions are used for deposition. On the other hand, since the metal ion concentration of the electroless plating solution 36 located in the region other than the resin section 22 temporarily decreases after the metal ions are deposited as the metal layer 33, the deposition rate of the metal layer 33 decreases. Therefore, the method of manufacturing the plated substrate 100 according to this embodiment can make the metal layer 33 on the resin section 22 thicker than the metal layer 33 provided in the region other than the predetermined pattern.

### 2. PLATED SUBSTRATE

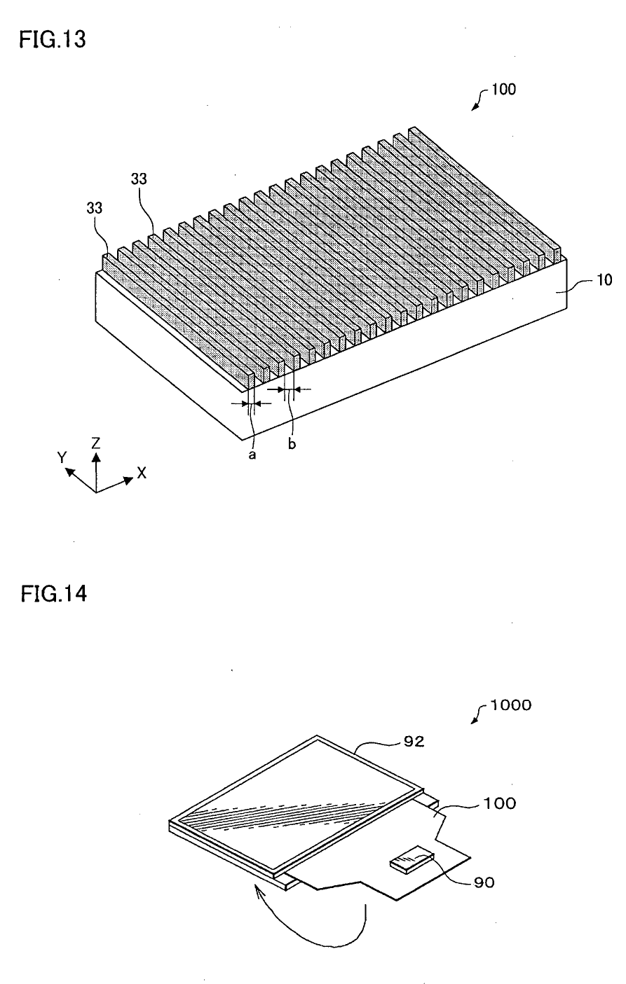

The plated substrate 100 manufactured by the above method is described below with reference to FIG. 13. FIG. 13 is a perspective view schematically showing the plated substrate 100 according to this embodiment. The plated substrate 100 includes the substrate 10 and the metal layer 33 formed on the substrate 10. The metal layer 33 has a predetermined pattern. The predetermined pattern may be a one-dimensional or two-dimensional periodic pattern, for example. Since the plated substrate 100 has the predetermined pattern on the optically-transparent substrate, the plated substrate 100 can function as an optical element substrate such as a polarizer. As shown in FIG. 13, the plated substrate 100 may have a one-dimensional periodic pattern (striped pattern) in which linear metal layers with a predetermined width a are repeatedly provided at predetermined intervals b along the X-axis direction. When the width a in the periodic direction (X-axis direction) is equal to or less than the wavelength of visible light and the substrate 10 is an optically-transparent substrate, the plated substrate 100 can function as a polarizer.

The plated substrate may have a width a of 30 nanometers to 200 nanometers and an interval b of 200 nanometers or less, for example.

### 3. ELECTRONIC DEVICE

FIG. 14 shows an example of an electronic device to which a plated substrate manufactured using the method of manufacturing a plated substrate according to this embodiment is applied. When the substrate 10 is an insulating substrate, the plated substrate 100 can function as a wiring substrate. An electronic device 1000 includes the plated substrate 100 as a wiring substrate, an integrated circuit chip 90, and another substrate 92.

The wiring pattern formed on the plated substrate 100 may be used to electrically connect electronic parts. The plated substrate 100 is manufactured by the above-described manufacturing method. In the example shown in FIG. 14, the integrated circuit chip 90 is electrically connected with the plated substrate 100, and one end of the plated substrate 100 is electrically connected with the other substrate 92 (e.g. display panel). The electronic device 1000 may be a display device such as a liquid crystal display device, a plasma display device, or an electroluminescent (EL) display device.

The plated substrate 100 as an optical element substrate may function as a polarizer for a liquid crystal display device, a projector device, and the like.

### 4. EXPERIMENTAL EXAMPLE

A plated substrate was formed using the method of manufacturing a plated substrate according to this embodiment.

(1) A resin section was formed on a glass substrate by the interference exposure method. Specifically, a photoresist film (resin material) was formed on the glass substrate. The photoresist film was linearly exposed and developed using a direct drawing method at a width of about 70 nanometers at a pitch of about 140 nanometers to form a resin section formed of the photoresist having straight lines with a width of about 70 nanometers and stripe-shaped openings with a width of about 70 nanometers.

(2) The glass substrate was cut into 1×1 cm squares, and immersed in a cationic surfactant solution (FPD conditioner manufactured by Technic Japan Incorporated). The glass substrate was then immersed in a palladium catalyst solution. A catalyst layer was formed on the top surfaces of the glass substrate and the resin section.

(3) The glass substrate on which the catalyst layer was formed was immersed in a nickel electroless plating solution at 80° C. for five minutes to form a nickel metal layer. The nickel metal layer had a thickness of about 80 nanometers on the top surface of the resin section and a thickness of about 20 nanometers between the resin sections.

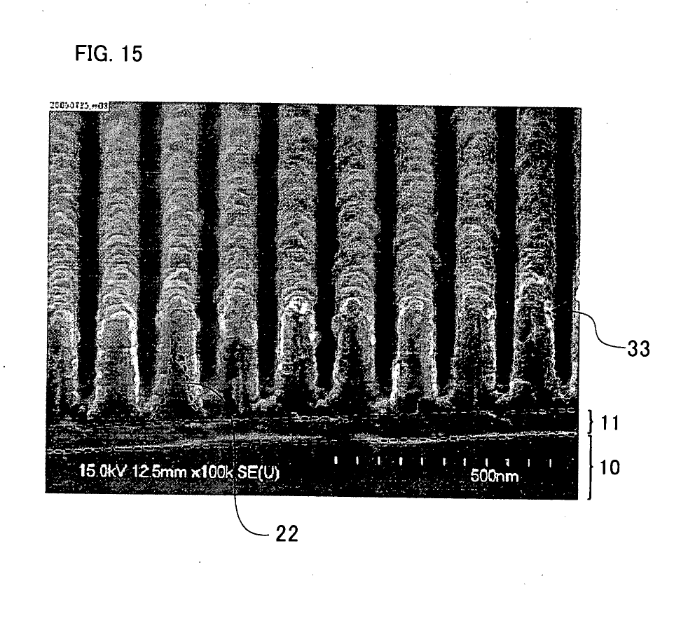

FIG. 15 shows an SEM image of the nickel metal layer thus formed. As shown in FIG. 15, the nickel metal layer was formed on the top surface of the resin section and in the region other than the resin section. It was confirmed that the thickness of the nickel metal layer on the resin section was greater than the thickness of the nickel metal layer formed in the region other than the resin section.

The invention includes configurations substantially the same as the configurations described in the embodiments (in function, method and effect, or in objective and result, for example). The invention also includes a configuration in which an unsubstantial portion in the described embodiments is replaced. The invention also includes a configuration having the same effects as the configurations described in the embodiments, or a configuration able to achieving the same objective. Further, the invention includes a configuration in which a publicly known technique is added to the configuration described in the embodiments.

Although only some embodiments of the invention have been described above in detail, those skilled in the art will readily appreciate that many modifications are possible in the embodiments without materially departing from the novel teachings and advantages of the invention. Accordingly, all such modifications are intended to be included within the scope of the invention:

What is claimed is:

1. A plated substrate having a metal layer formed by electroless plating, the plated substrate comprising:
a resin section formed on a substrate and having a predetermined pattern;
a catalyst layer formed on the resin section; and
a metal layer formed on the catalyst layer.

2. The plated substrate as defined in claim 1,
the metal layer being formed above part of the substrate on which the resin section is formed and also above remaining part of the substrate on which the resin section is not formed; and
a thickness of the metal layer at a position above the part of the substrate on which the resin section is formed being greater than a thickness of the metal layer at a position above the remaining part of the substrate on which the resin section is not formed.

3. The plated substrate as defined in claim 1, further comprising a catalyst adsorption layer formed between the resin section and the catalyst layer.

4. The plated substrate as defined in claim 1, wherein the resin section includes a photoresist.

5. The plated substrate as defined in claim 1, wherein the substrate is a transparent substrate transmitting light having a predetermined wavelength.

6. A method of manufacturing a plated substrate using electroless plating to form a metal layer, the method comprising:
(a) forming a resin section having a predetermined pattern on a substrate;
(b) forming a catalyst layer on the resin section; and
(c) depositing a metal on the catalyst layer by immersing the substrate in an electroless plating solution to form a metal layer.

7. The method of manufacturing a plated substrate as defined in claim 6,
wherein the step (a) includes:
applying a resin material in a fluid state to the substrate;
pressing a nanostamper having a predetermined recessed pattern against the substrate to transfer the predetermined recessed pattern to the resin material; and
curing the resin material.

8. The method of manufacturing a plated substrate as defined in claim 7,
wherein an upper portion of the cured resin material and a portion of the cured resin material not having the transferred predetermined pattern are removed by ashing between the steps (a) and (b).

9. The method of manufacturing a plated substrate as defined in claim 6,
wherein the resin section includes a photoresist; and
wherein the resin section is formed by an interference exposure method in the step (a).

10. The method of manufacturing a plated substrate as defined in claim 6, further comprising:
(d) removing part of the resin section by immersing the substrate in an alkaline solution between the steps (a) and (b).

11. The method of manufacturing a plated substrate as defined in claim 10, further comprising:
forming a catalyst adsorption layer on the resin section on the substrate between the steps (d) and (b).

12. The method of manufacturing a plated substrate as defined in claim 6,
wherein, between the steps (a) and (b), part of the resin section is removed and a surfactant layer is formed on the resin section on the substrate by immersing the substrate in an alkaline surfactant solution.
